(19) United States
(12) Patent Application Publication
(10) Pub. No.: US 2012/0329524 A1
(43) Pub. Date: Dec. 27, 2012

(54) TOUCH SENSOR AND ANTENNA INTEGRATION ALONG AN ELECTRONIC DEVICE HOUSING

(76) Inventors: Joel C. Kent, Fremont, CA (US); Ting Gao, Sunnyvale, CA (US); Bruce F. Bishop, Aptos, CA (US)

(21) Appl. No.: 13/166,149

(22) Filed: Jun. 22, 2011

(51) Int. Cl. H04W 88/02

(52) U.S. Cl. 455/566

(57) ABSTRACT

An electronic device includes a housing defining first and second user interface areas, a touch-sensitive display disposed in the first user interface area, and a conductive structure disposed along the housing in the second user interface area. The electronic device further includes a capacitive touch controller disposed within the housing and coupled to the conductive structure, the capacitive touch controller being configured to capture user interaction with the conductive structure, and a transceiver disposed within the housing and coupled to the conductive structure, the transceiver being configured for radio frequency (RF) communications. The conductive structure is configured for operation as an antenna to support the RF communications.

### FIELD

The disclosure relates generally to electronic devices and, more particularly, to electronic devices capable of wireless communications.

### BACKGROUND

Handheld electronic devices utilize a number of electrical components to support various input/output (I/O) functions. Some components form a user interface for the device. For example, handheld devices like mobile phones often have a display, a keyboard, or a touchscreen as primary user interface components. Push buttons, scroll wheels, and sliders are examples of other user interface components occupying space along the housing. Other components provide interfaces to support communications with other electronic devices. To that end, handheld electronic devices commonly include card slots, I/O ports, plug receptacles, and other connectors.

These I/O components compete for space on a device housing amidst an ongoing trend toward smaller devices.

The housings of electronic devices may accommodate one or more antennas that support wireless communications. Electronic devices use long-range wireless communication systems, such as cellular telephone systems, to receive and transmit communications over, for instance, the Global System for Mobile Communications (GSM) telephone bands. Electronic devices may also use short-range wireless communication protocols to support communications with nearby devices, including WiFi™ (IEEE 802.11) and the Bluetooth™ devices.

The positioning of antennas presents additional challenges for smaller device housings. Handheld devices have largely abandoned antenna designs in which a post projects outward from the device housing. Device housings are routinely designed with internal antenna elements, either entirely disposed within the housing, or forming part of the housing itself. However, with antennas within or along the device housing, the presence of a user's hand can degrade performance. Antennas are routinely located along the device housing despite the increased likelihood for these detrimental effects. Complicating matters further for antenna design are the ever increasing demands for additional space required by the other I/O components.

### SUMMARY

In accordance with one embodiment, an electronic device includes a housing defining first and second user interface areas, a touch-sensitive display disposed in the first user interface area, a conductive structure disposed along the housing in the second user interface area, a capacitive touch controller disposed within the housing and coupled to the conductive structure, the capacitive touch controller being configured to capture user interaction with the conductive structure, and a transceiver disposed within the housing and coupled to the conductive structure, the transceiver being configured for radio frequency (RF) communications with the conductive structure as an antenna.

In accordance with another embodiment, an electronic device includes a housing, an antenna disposed along the housing, a transceiver providing RF communications, a capacitive touch controller coupled to the antenna, and a processor coupled to the transceiver and the capacitive touch controller. The transceiver is coupled to the antenna, the capacitive touch controller is configured to generate an indication of a conduction environment for the antenna, and the processor is configured to adjust the configuration of the transceiver based on the indication generated by the capacitive touch controller.

In accordance with another embodiment, a method for input/output operation of an electronic device includes sensing a capacitive interaction of a user on a conductive structure of the electronic device, configuring a transceiver of the electronic device as a function of the capacitive interaction, and transmitting or receiving radio frequency (RF) communications via the transceiver as configured.

These and other embodiments are described in more detail in conjunction with the following drawings.

### BRIEF DESCRIPTION OF THE DRAWINGS

FIG. 1 is a schematic diagram of an electronic device including an antenna coupled to both wireless circuitry and touch sensor circuitry in accordance with one embodiment.

FIG. 2 is a flow diagram of a method to adjust a configuration of a radio frequency (RF) transceiver in accordance with one embodiment.

FIG. 3 is a perspective view of a housing shell having an arrangement of conductive structures configured as antenna elements and/or capacitive touch electrodes in accordance with one embodiment.

FIG. 4 is a schematic view of an alternative arrangement of conductive structures configured as antenna elements and/or capacitive touch electrodes.

FIG. 5 is a schematic view of yet another alternative arrangement of conductive structures configured as antenna elements and/or capacitive touch electrodes.

FIG. 6 is a perspective view of one example of a handheld electronic device having a housing with a number of user interface elements constructed in accordance with one embodiment.

FIG. 7 is an exploded, side view of the handheld electronic device of FIG. 6.

FIG. 8 is an exploded, perspective view of a housing front shell (or frame) and a circuit board of the handheld electronic device of FIG. 6.

FIG. 9 is an exploded, perspective view of the circuit board and a housing back shell of the handheld electronic device of FIG. 6, the housing back shell having an arrangement of conductive structures configured as antenna elements and/or capacitive touch electrodes in accordance with one embodiment.

### DETAILED DESCRIPTION OF THE SPECIFIC EMBODIMENTS

The disclosure generally relates to electronic devices having conductive structures disposed on, in, or otherwise along housing shells and other components for various input/output (I/O) functions, including wireless communications and touch-sensitive user interfaces. Making areas of the housing sensitive to touch events increases the touch control and interaction capabilities of an electronic device, which may already include a touchscreen, without necessitating an increase in device size. The disclosed devices provide advantages beyond mere increased touch control by integrating such touch-sensitive housing interfaces with other I/O functionality, such as radio frequency (RF) communications. The terms “RF” and “RF communications” are used broadly to include a wide range of wireless communications, including, for instance, those falling within the microwave frequency range.

In one aspect, the conductive structures disposed on, in, or otherwise along the housing may be collectively or individually configured to support multiple input/output (I/O) functions, including both wireless communications and capacitive touch sensing. For example, a conductive trace may be used for two different functions—as both an antenna element and a capacitive touch electrode—making the electronic devices smaller and adding I/O functions to an already crowded device housing. In other embodiments, where separate conductive traces or structures are deposited on the housing to handle various I/O functions separately, the same manufacturing processes and materials may nonetheless be used to form the conductive structures. Any increase in cost to provide the increased touch interaction capability is minimized with antennas acting as capacitive touch electrodes, and/or through the use of the same manufacturing process steps for touch electrodes and antenna elements.

The use of the same conductive structure(s) for both antenna and touch sensing functions may also be supported by circuitry, such as capacitive and inductive filters, that couple the conductive structure(s) to respective control electronics, i.e., wireless circuitry and touch sensor circuitry. For example, a capacitive or other high pass or high bandpass filter may couple a conductive structure to a transceiver of the RF circuitry to allow a desired RF frequency band to pass while blocking the relatively low signal frequencies used for capacitive touch sensing. An inductive or other low pass or low bandpass filter, in turn, may couple the conductive structure to a capacitive touch controller so that the low frequency touch sensing signals pass while the higher frequency RF signals are blocked.

Another aspect of the integration of I/O functions of the disclosed devices is directed to providing information regarding changes to the conduction environment arising from the presence of an operator's hand or other body part. With this information, steps may then be taken to compensate for an operator's hand near or covering a portion of an antenna element disposed along the device housing. For instance, a processor uses the information from the sensor circuitry to retune or otherwise adjust the wireless circuitry and/or antenna(s). It is possible for wireless electronics to adapt to hand effects and minimize antenna performance degradation if provided information regarding the presence or absence of a hand covering or otherwise near the antenna. One or more touch interface electrodes of the disclosed devices may provide the wireless electronics with such information. In some embodiments, the antenna element itself is also coupled to the touch sensor circuitry and thus also acts as a capacitive touch sensor. In other embodiments, the disclosed devices include additional, single-purpose conductive structures near an antenna element to provide the information on hand position. That is, conductive structures dedicated solely to touch sensing functions can also provide useful information to support the RF communications (despite not necessarily acting as an antenna therefor). In this way, antenna performance may be improved based on the information even in those cases in which the operator hand is nearby, rather than covering, the antenna element.

The multiple uses for conductive structures disposed on, in, or otherwise along the device housing are particularly advantageous in the context of handheld electronic devices. Examples of handheld electronic devices include mobile phones, personal data assistants (PDAs), laptops, tablet personal computers (PCs), netbooks, e-readers, remote controls, various media and game players, and other navigation and communication devices. Notwithstanding the foregoing list and the advantages and examples described herein, the teachings of the disclosure are not limited to handheld devices or any other category or type of electronic device. For example, one or more housing components of a laptop computer may be configured with the integrated antenna and touch sensing technologies described herein.

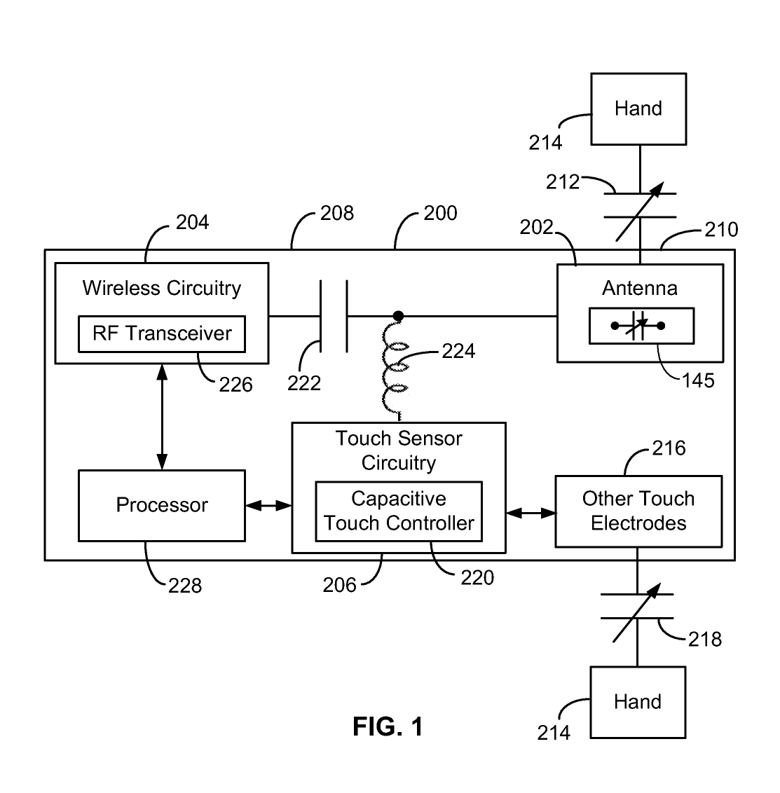

FIG. 1 depicts one example of an electronic device 200 having a conductive structure 202 that supports multiple I/O functions, according to a specific embodiment. In this embodiment, the conductive structure 202 is coupled to, or connected with, both wireless circuitry 204 and touch sensor circuitry 206 to support RF communications and a touch-sensitive user interface, respectively. The conductive structure 202 may be disposed within an interior space defined by a housing 208 of the device 200. For instance, the conductive structure 202 may include one or more conductive traces disposed on or otherwise along an interior surface of the device housing 208. However, the conductive structure 202 need not be disposed within the interior space defined by the device housing 208 as shown, but instead be embedded or otherwise integrated with the device housing 208 itself. The conductive structure 202 may have any layout, orientation or configuration that positions the conductive structure 202 along the device housing 208 to act as a capacitive touch electrode. Conductive structures along a device housing include, for instance, conductive structures on the housing, conductive structures in the housing (e.g., embedded structures), and conductive structures that form part of the housing as the structures are disposed along other components of the housing (e.g., as an edge sandwiched between two housing shells or frames).

An area 210 of the device housing 208 in the vicinity of the conductive trace(s) is operative as a capacitive touch interface. The capacitive touch interfaces senses the user, such as the presence or movement of a user's hand. The sensing is of a variable capacitance caused by the user. The variable capacitance is indicated schematically at 212 as a variable capacitance C_{touch} between an operator hand 214 and the conductive structure 202. The area 210 of the device housing 208 may correspond with a back side of the housing 208 opposite a front side or area having, for instance, a touch-sensitive display or touchscreen. Alternatively or additionally, one or more edges or other sides or faces of the device housing 208 may be capacitive touch interfaces via conductive structures or traces. In these ways, the conductive structure(s) 202 may significantly expand the touch-sensitive capabilities of the device 200.

The capacitive touch interface 212 may be configured as a projected capacitive touch interface. User interaction in three dimensions (i.e., the X and Y lateral dimensions as well as the Z range dimension) can be sensed. The nature of the interface 212 may also be considered projective in those cases where the touch electrode is disposed on an inner surface of the device housing 208, in which case it may be separated from a finger touching the housing 208 by the thickness of the housing 208. The projected capacitive touch interface 212 can sense the touch, gestures, and/or other user interactions through device housing thicknesses of, for instance, about 2.5 mm of plastic material. The capacitive touch interface 212 also may support the capture of gestures involving a user interaction that hovers above the device housing 208. For example, non-contact gestures involving swipe left and swipe right may be used. In addition, contact gestures such as touch, drag, and two-finger zoom may be used.

One or more conductive traces of the conductive structure 202 may be generally configured to act as an antenna or an antenna element to support RF communications with the device 200. The disposition of the conductive trace(s) of the conductive structure 202 along the device housing 208 helps to ensure adequate reception and transmission of the RF signals. The layout, shape, length, material, and other characteristics of the conductive structure 202 may also be selected to ensure adequate reception and transmission. The conductive structure 202 may also include one or more conductive traces that are dedicated solely to supporting the touch interface 212. Such single-purpose conductive structures or traces may nonetheless be disposed proximate to the user interface area 210 where the antenna is located. The conductive structure or traces may be made of metal, conductive polymer, printed conductive inks that include metal and conductive polymers, over-molded or printed conductive composites, over-molded/casted low softening temperature alloy materials (“liquid metals”), in some embodiments. In this way, the single-purpose conductive structures can improve the performance of the touch interface or, as described below, also improve the performance of the wireless communications.

The device housing 208 may be made of a plastic or other non-conductive material in the area 210 along which the conductive structure 202 is disposed. Alternatively or additionally, the device housing 208 may have an opening in which the conductive structure 202 is disposed, in which case a dielectric film or other non-conductive layer (e.g., a gasket) may space and separate the conductive structure 202 from the device housing 208. In that and other cases, the device housing 208 may be made of a conductive material. More generally, the structure, material, configuration, and other characteristics of the device housing 208 may vary considerably. While one or more traces or segments of the conductive structure 202 may constitute, be formed, or lie along, an exterior surface of the device housing 208, the wireless circuitry 204, the touch sensor circuitry 206, and most, if not all, of the other components of the device 200 are disposed within the housing 208.

The device 200 may include no other, or a number of, touch-sensitive user interfaces or user interface elements, schematically indicated at 216, in addition to the capacitive touch interface 212. One of the additional user interfaces 216 may include a touch-sensitive display or touchscreen, which may constitute a primary or main user interface of the device 200. In some cases, one or more of these user interfaces 216, such as a touch-sensitive display or touchscreen, may be disposed in another opening in the housing 208, which may be shaped as a frame to capture the display as described below. These other touch-sensitive user interfaces 216 need not be disposed along a different side or surface of the device housing 208 than the interface 212 supported by the conductive structure 202, and instead may be disposed on the same side. Indeed, the interfaces may be integrated to any desired extent, including those instances in which the distinction of the interfaces is, in fact, transparent to the operator. In other words, the area 210 may constitute a region of one of the user interfaces 216, the area 210 differing from the remainder of the user interface 216 in that the conductive traces in the area 210 also serve as antenna elements.

The capacitive touch interface 212 supported by the conductive structure 202 may be considered to extend the touch interaction capabilities of the device 200 beyond a primary touchscreen by providing a secondary or auxiliary user interface of the device 200. For instance, the capacitive touch interface 212 may support additional interaction with the touch-screen display or other user interfaces 216 by, for instance, allowing a user to control or manipulate a cursor. Alternatively or additionally, the capacitive touch interface 212 may be dedicated to capturing a pre-defined set of gestures, taps, or other touch events directed to specific device functions (e.g., on/off, sleep, volume up/down, hang up, hold call, etc.). Such gestures are often easier to capture with capacitive sensing than the touch information required by the touchscreen of the device.

Because the capacitive touch interface 212 need not provide the precision or other capabilities of a primary touch interface, the resolution and other characteristics of the arrangement of the conductive structures or traces 202 need not be as complex or detailed as those supporting the primary interface. The relaxation of the touch interface requirements, in turn, allows the conductive structures or traces to be configured in a manner that maximizes antenna performance. For example, the length and other dimensions of the conductive structure(s) may be selected to maximize reception and transmission in the frequency band(s) of the RF communications. Notwithstanding the foregoing, the size, shape, configuration, layout, number, structure, material, and other characteristics of the conductive structure 202 may vary considerably.

The device 200 may have any number of other touch-sensitive interfaces 216, each of which need not be a capacitive touch interface 218 as shown in the example of FIG. 1. For instance, one of the examples described below has an acoustic touch-sensitive display or touchscreen supported by a number of piezoelectric transducers, as well as a number of auxiliary user interface elements that also rely on acoustic transducers to capture user interactions. In such cases, the touch sensor circuitry 206 may include one or more touch controllers or function(s), in addition to a capacitive touch controller 220 or function(s), for processing the signals from the acoustic transducers. The capacitive touch controller 220 may operate in self-capacitive mode (e.g., measuring capacitance from the conductive structure 202 and ground including via a user's touch), or may operate in mutual capacitive mode (e.g., measuring capacitance between the conductive structure 202 and another conductive structure that may be changed by a user's touch), or may operate in both self-capacitive and mutual-capacitive modes.

One or more filters may be used to couple the conductive structure(s) 202 to the wireless circuitry 204 and the touch sensor circuitry 206. The filter(s) are generally operative to isolate the wireless circuitry 204 from the touch sensor circuitry 206 while still allowing simultaneous use and operation of the antenna and capacitive touch interface functions. The operation of the multiple I/O functions need not rely on time division multiplexing or other staged operation, but may operate sequentially or simultaneously. There is a wide disparity in the signal frequencies of the two I/O functions. The RF frequencies used by the wireless circuitry 204 are generally and typically above about 500 MHz and up to GHz ranges, while the touch sensor circuitry 206 senses changes to the variable capacitance C_{touch} arising from the proximity of an operator hand at much lower frequencies, typically below 10 MHz. With such a wide disparity in the signals of interest, the configuration of the filter(s) may vary considerably, presenting any combination of bandpass, low-pass, high-pass, notch or other filter responses.

In the exemplary embodiment shown in FIG. 1, the conductive structure 202 may be coupled to, or connected with, the wireless circuitry 204 via a capacitive or other filter 222 that provides a high-pass or high-bandpass filter response. The terms “coupled” and “connected” include both direct and indirect links, couplings or connections between elements. The filter blocks or reduces the lower frequencies of the touch sensor circuitry 206 while passing the GHz band(s) of the RF communications. The capacitive filter 222 may include a series capacitance 222 on the order of about 10 pF in one example. More generally, any high pass filter that passes RF communication signals and blocks touch excitation signals may be placed between the conductive structure 202 and the wireless circuitry 204. An inductive filter 224 may, in turn, couple the conductive structure 202 to the touch sensor circuitry 206. The inductive filter 224 provides a low-pass filter response that blocks or reduces the high frequency band(s) of the RF communications while passing the MHz signals representative of the changes to the variable capacitance C_{touch}. In one example, the inductive filter 222 includes a series inductance on the order of about 100 μH. More generally, any low-pass or low-bandpass filter that blocks RF communication signals and passes touch interface excitation signals may be placed between the conductive structure 202 and the touch sensor circuitry 206. A variety of other filter configurations may be used to effectively disconnect the wireless circuitry 204 from the touch sensor circuitry 206.

The wireless circuitry 204 may include any number of transceivers 226 dedicated to different RF communication signals. For example, the wireless circuitry may include respective transceivers configured to support Bluetooth signals, WiFi signals, global positioning system (GPS) signals, mobile phone signals, and/or any other RF communication protocol or standard.

The touch sensor circuitry 206 may include a commercially available capacitive touch controller. One suitable controller is provided on an integrated circuit chip available from Analog Devices under model number AD7147.

Coupled to the wireless circuitry 204 and the touch sensor circuitry 206 for communication therewith, the electronic device 200 includes a processor 228 disposed in the housing 208 and coupled to the wireless circuitry 204 and the touch sensor circuitry 206 for communication therewith. The processor 228 may be responsible for controlling or directing a wide variety of device functions, including the I/O functions related to the conductive structure 202. The processor 228 is separate from the capacitive touch controller 220 and the wireless circuitry 204, but may instead be implemented by one of these components. In operation, the processor 228 generally receives information indicative of touch events and other operator interaction with the area 210 in the form of C_{touch} data from the capacitive touch controller 220 of the touch sensor circuitry 206. Each indication of a touch event or other operator interaction may then be used by the processor 228 to initiate various device actions based on the location of a touch, the nature of a gesture, or other characteristic of the interaction. However, each indication of a touch event may also or alternatively be analyzed by the processor 228 to determine whether adjustments to the wireless circuitry 204 are warranted due to the way in which the operator is holding the device 200. The change in the variable capacitance may be indicative of an operator holding the device 200 in a manner relevant to the performance of the wireless communication function. The conductive structure 202 is able to provide such information because the same conductive trace(s) is being used as an antenna element and as a touch electrode. In other embodiments, a conductive structure of a touch electrode is able to provide such information because the conductive structure of the touch electrode is in a location in proximity to the antenna.

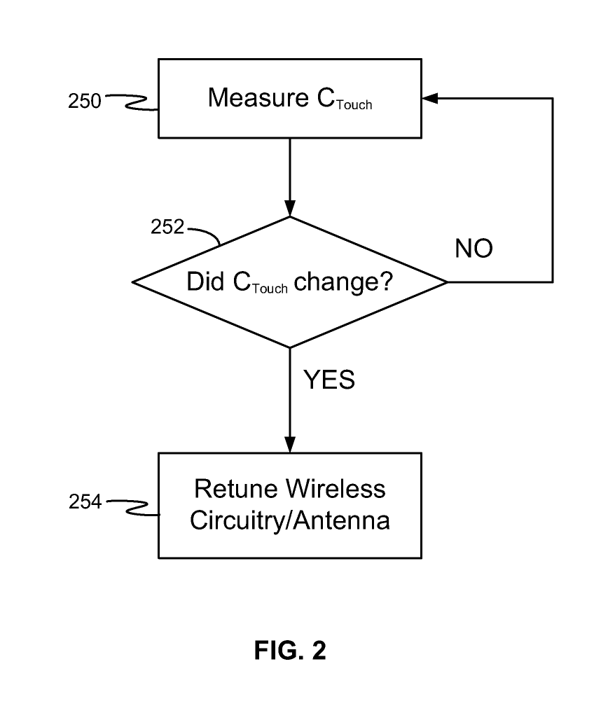

Turning to FIG. 2, the processor 228 may be configured to implement a procedure generally directed to addressing wireless performance degradation resulting from the change in the conduction environment near the antenna. The change in the conduction environment may arise from, for instance, the position of the operator's hand on the device housing. Each indication of operator interaction with the capacitive touch interface 212 or 218 established by the conductive structure 202 (FIG. 1) may be used by the processor 228 to retune or otherwise adjust the transceiver 226 of the wireless circuitry 204 and/or the antenna(s). In some cases, the indication may also be representative of a location on the antenna covered by the operator's hand, which may enable the processor 228 to take more targeted action to improve wireless performance. A sensed change, periodic sensing, or other action may trigger implementation of the procedure.

In the example shown in FIG. 2, the processor 228 is configured to implement a software routine or procedure in which a measurement of the variable capacitance C_{touch} (or a representative indication thereof) is determined in a block 250. The measurement is determined from or is the information provided by the capacitive touch controller 220 (FIG. 1). The determination may be made in any desired manner (e.g., look-up table, etc.). Given the data from the determination, the processor 228 then analyzes in a decision block 252 whether the variable capacitance changed relative to, for instance, a previous measurement, a rolling average, or some other value representative of a previous or comparative operational state or a threshold capacitance. The analysis may include a calculation of a differential value and a comparison of the differential value with a threshold level indicative of a substantial change in the conduction environment. If the differential value does not cross the threshold level, then control may return to the block 250 for further data gathering. If the differential value crosses the threshold level, then control passes to a block 254 in which the processor 228 directs the transceiver 226 (FIG. 1) of the wireless circuitry 204 (FIG. 1) to make adjustments to address the substantial change in the conduction environment. For example, the processor 228 may send a control signal to the transceiver 226 to adjust a tuning mechanism (such as tuning device 145) to retune the wireless circuitry 204 and/or antenna 202. The procedure may then return to the block 250 or may include one or more additional steps to analyze the efficacy of the adjustment, perform further adjustments (e.g., feedback for fine tuning), and return control to the block 250 for future analysis.

The retuning or adjustment of the transceiver 226 and/or antenna(s) may include or involve firmware, a circuit element, or other component in communication with the transceiver 226 and/or antenna(s). For instance, the adjustment may involve a switch that selects one of a plurality of circuit elements to be coupled to the antenna element to adjust its antenna-circuitry frequency response and/or impedance matching characteristics, for example to maintain optimization for the same communication frequency despite frequency and impedance detuning effects of a hand near the antenna. Another example may involve adjustments to the power level of an amplifier in the transmit or receive path. Yet another example may involve adjustments that select one of a plurality of antenna elements for use given a particular operator hand position. When the performance of one antenna element is compromised by an operator hand, the transceiver 226 may then retune the antenna(s) or may direct a switch to select a different antenna element, the performance of which is not presently being adversely affected by the operator's hand. The manner in which the transceiver 226 and the wireless circuitry 204 address changes in the conduction environment given the information from the touch interface may include any combination of the foregoing examples, according to specific embodiments. Adjustment of firmware or hardware components coupled to parts of the transceiver 226 may be an adjustment to the transceiver 226 itself.

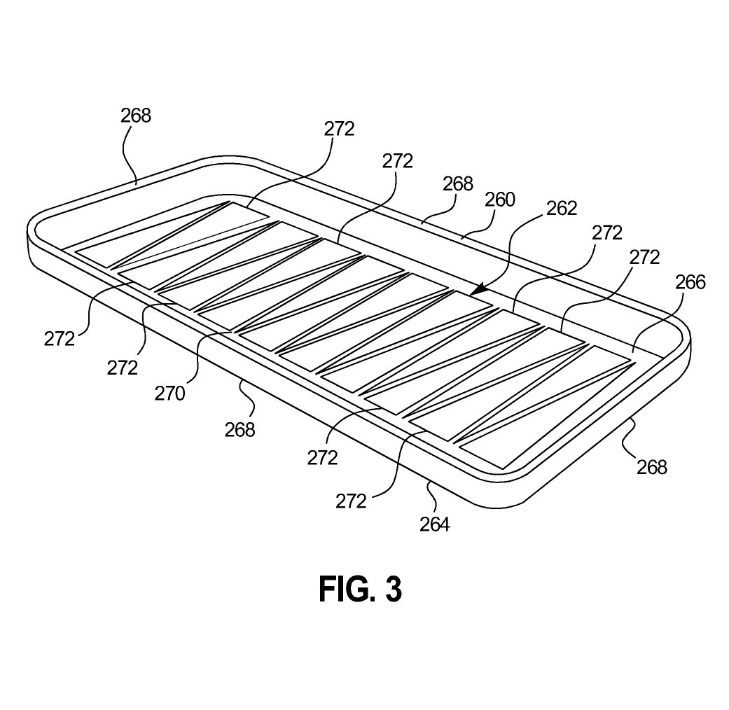

FIG. 3 depicts one example of a device housing 260 having a conductive structure 262 configured to support both touch interface and antenna functions. In this example, the device housing 260 includes a shell 264 that defines a back side of the device housing 260. The shell 264 may be configured as a half-shell that engages a frame or other half-shell (not shown) in a two-piece construction. Other configurations, such as a plate or just a base panel, may be used. The shell 264 includes a base panel 266 surrounded by sidewalls 268 that may define the edges of the housing 260. The base panel 266 has an inner surface 270 on which the conductive structure 262 is deposited. The conductive structure 262 includes a plurality of conductive traces 272 arranged in a pattern to establish a touch-sensitive user interface area along the back side of the device housing 260. In this example, each trace 272 is configured as a solid pad, the width of which may be useful to support the current levels encountered during antenna operation. In other examples, one or more of the traces 272 may be configured as a set of conductive lines that track and define the outline of the respective trace 272.

The conductive structure 262 in the example of FIG. 3 covers the base panel 266 in a single layer that supports the touch interface function. Each conductive trace 272 in the single layer forms a tapered electrode to provide position information for both lateral coordinates (i.e., x and y). Adjacent electrodes alternately taper in opposite directions to maximize coverage of the base panel 266 as well as to develop an indication of the lateral position of the touch event. In this example, the single layer of conductive traces 272 is disposed in a backgammon arrangement. Further details regarding this type of single layer, backgammon electrode arrangement, including alternative conductive structures suitable for use with the disclosed devices, are set forth in U.S. Pat. No. 6,297,811 (“Projective Capacitive Touchscreen”), the entire disclosure of which is hereby incorporated by reference.

The single-layer electrode arrangement may not provide the resolution and other high performance characteristics of double-layer and other capacitive touch electrode arrangements. This difference is not necessarily detrimental, however, because the capacitive touch interface established by the conductive structure 262 may be relied upon as a secondary or auxiliary interface. The device formed via the housing 260 may include a primary touch-sensitive display or touchscreen on a front side (not shown) of the housing 260 with touch electrode (or other transducer) arrangements that provide a user interface area that satisfy the resolution and other performance requirements of the device. As described herein, the capacitive touch interface supported by the conductive structure 262 may instead be relied upon for capturing gestures and other touch events that do not require high resolution or precision. This aspect of the conductive structure 262 may also allow the electrode arrangement to be tailored for antenna performance. Notwithstanding the foregoing, one or more traces of the conductive structure 262 may be complemented by another layer (not shown) of electrodes (e.g., embedded in the housing) to improve touch interface performance in other embodiments. High resolution sensing may be used.

Each conductive trace 272 may be deposited on the inner surface 270 via a variety of manufacturing processes. In one example, the traces 272 may be made of metal, composite polymer materials, liquid metals, and/or other materials well suited for use with injection molding processes. Using molds to form the conductive traces 272 may be advantageous in those cases in which the shell 264 is also mold-processed. The traces 272 may also be formed via electroplating processes and, thus, be made of any metal (e.g., Cu, Ni, etc.) or other conductive material that can be plated. The traces 272 may alternatively be printed on the inner surface 270 via conventional direct printing techniques.

The device 200 may have any number of conductive structures or traces arranged in any desired pattern to provide the capacitive touch interface. One or more of the conductive structures or traces need not be coupled to the wireless circuitry 204 (FIG. 1). That is, not every trace 272 needs to be acting as an antenna. It may be desirable for wireless performance if only one or more of the traces 272 provides the antenna function at any one point in time. Thus, one subset of the conductive structures or traces may be configured for operation as an antenna and a capacitive touch interface, while another subset of the conductive structures or traces may be configured for operation only as a capacitive touch interface. In that case, the conductive structures or traces of the two subsets may nonetheless be disposed in the same area of the device housing 208. The information provided by both subsets may be used to improve antenna performance by indicating the positioning of the operator's hand.

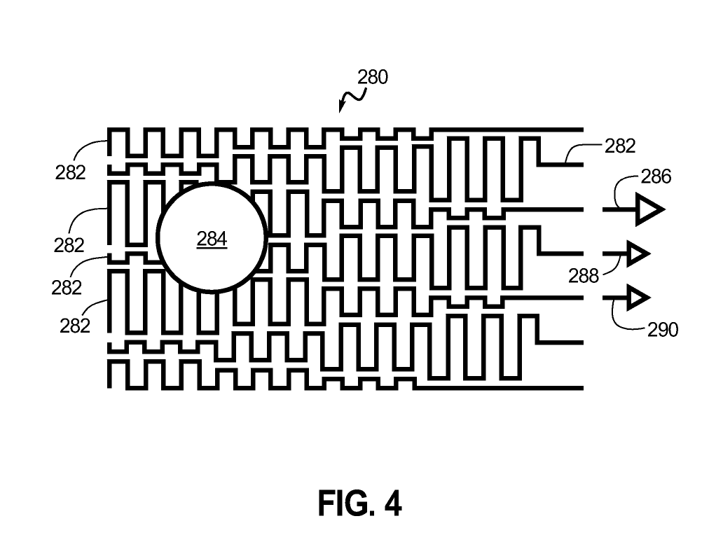

With reference now to FIG. 4, the operation of a backgammon electrode arrangement is illustrated in connection with an alternative configuration. In this example, a conductive structure 280 includes a plurality of serpentine traces 282 that form an outline in the backgammon pattern. Adjacent traces 282 are tapered in alternate directions to vary the extent to which a touch event modifies the variable capacitance signal of each trace. This effect is shown via a touch event represented by a circle 284 that covers three adjacent traces 282. As a result of the tapering, the capacitive change in one of the traces 282 is high, as shown by a large arrow 286, while the capacitive change in the other two traces 282 is low, as shown by smaller arrows 288, 290. The change in the trace 282 associated with the small arrow 288 is lower due to the smaller size of the trace 282 in the touch event area. The change in the trace 282 associated with the arrow 290 is lower because only a portion of the trace 282 is impacted by the touch event. Given all three signals, both lateral coordinates of the touch event may be determined. The resolution of the interface may be based on the density of the traces 282.

A variety of other single-layer electrode arrangements and configurations may be used. For example, the conductive traces may be arranged in one or more rows of rectangles rather than the backgammon arrangement described above. A row of rectangles provides another example of a cost-efficient and otherwise pragmatic way in which one-dimensional gestures or other touch events may be captured in the capacitive touch interface along the device housing.

The conductive structures illustrated in FIGS. 3 and 4 have shapes more optimized for capacitive touch sensing performance and application rather than shapes that optimize antenna function. In balancing the trade-off between optimizing shape for capacitive touch sensing function and optimizing shape for antenna function, at least some conductive structures may include irregular patterns (e.g., rather than the regular patterns illustrated in FIGS. 3 and 4) and assume shapes more well-suited for antenna function. While irregularly patterned electrodes may compromise touch interface performance, the performance may still be sufficient for the gestures or other interactions of interest. Alternatively, the conductive structure may simultaneously optimize conductive structure shape for both touch input device and antenna functions by making use of frequency filtering effects within the conductive structure itself, as described below.

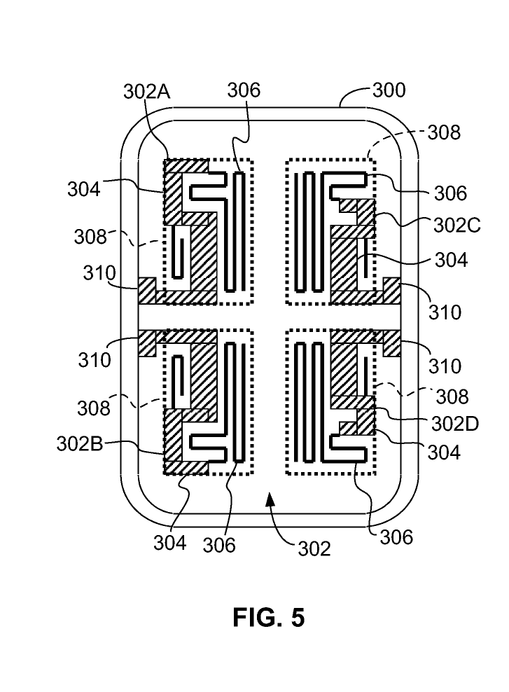

FIG. 5 illustrates a shell 300 with multiple conductive structures 302A-302D shaped to support two dipole antennas and also shaped to support a projected capacitive quadrant detector for use with non-contact swipe gestures, according to an exemplary embodiment. Alternatively, the conductive structures 302A-302D may be coupled to one another or otherwise configured to act as a single, collective conductive structure 302. Each of the conductive structures 302A-302D includes a solid area portion 304 (indicated by the cross hashed area) and a mesh, serpentine patterned, or other sparse area portion 306. The non-sparse, solid area portions 304 of the conductive structures 302A-302D have a relatively low impedance at the high frequencies used for wireless communications. In contrast, the resistance and inductance associated with the sparse area portions 306 have relatively high effective impedances at wireless communication frequencies relative to characteristic antenna impedances, which are typically on the order of tens of Ohms. This contrast greatly reduces the effect of the sparse area portions 306 on the antenna function. The effect of the conductive structure shape for antenna function is determined largely by the solid portions 304 of the conductive structures 302A-302D. In contrast, the resistance and inductance associated with the sparse area portions 306 result in a low effective impedance at capacitive touch sensing frequencies relative to the characteristic impedance of the touch capacitance of a finger touch, which are typically tens of kiloOhms or more. Each conductive structure 302A-302D provides a capacitive touch-sensitive interface area 308, which is supported by the combination of the solid area portions 304 as well as the sparse area portions 306 of the conductive structure 302A-302D. The pattern and arrangement of the portions 304 and 306 may vary considerably from the example shown and remain configured to optimize both antenna and capacitive touch sensing functions.

As shown in FIG. 5, the solid area portions 304 may terminate at pads 310, each of which may represent a respective feed point for corresponding monopole antenna structures fed against the device ground plane. The four conductive structures 302A-302D may form four independent antennas for wireless communications, which may, for instance, correspond with a main cell antenna, a diversity cell antenna, a GPS antenna, and a WiFi™ antenna. The four conductive structures 302A-302D may also concurrently form four capacitive touch sensing electrodes for use in a quadrant detector. For example, a downward swipe gesture, either with or without finger contact with the exterior shell surface, along the middle of the structure 302 may be recognized by a capacitive signal that is initially detected more strongly in capacitive touch sensing electrode channels connected to the structures 302A and 302C and then more strongly detected in the structures 302B and 302D. Many other gestures and input methods may be supported by such a capacitive quadrant sensor. The antenna function associated with the structures 302A and 302B may be designed for a different wireless communication frequency than the antenna associated with the structures 302C and 302D, but nevertheless provide four conductive structures that form functionally symmetric quadrant electrodes for capacitive sensing purposes.

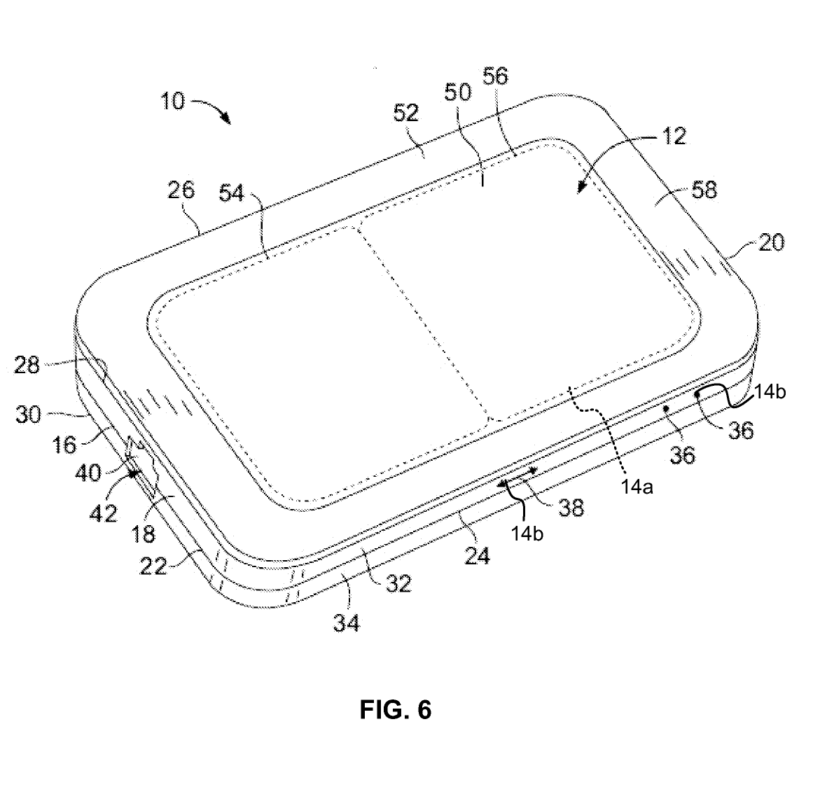

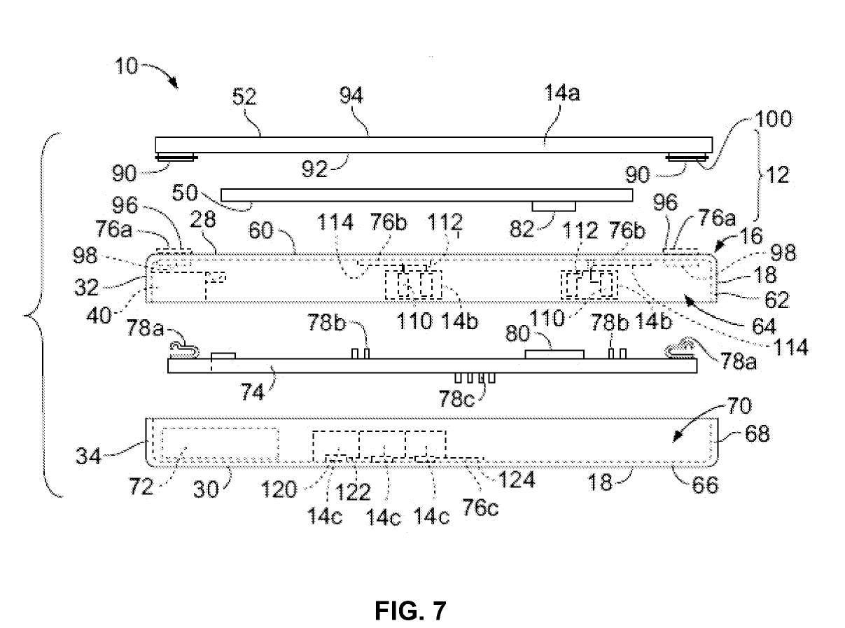

FIG. 6 illustrates an electronic device 10, such as a mobile phone constructed in accordance with an exemplary embodiment. The electronic device 10 represents a handheld consumer electronic device having a user interface 12, which, in turn, may be considered to include a number of user interface elements 14a, 14b, 14c (see also FIG. 7). The user interface 12 is configured to display data to an operator. The user interface elements 14a, 14b, 14c are manipulated by an operator to control the display and functionality of the electronic device 10. The number, location, purpose, functionality, and other characteristics of the user interface elements 14a, 14b, 14c may vary significantly from the example shown, as the electronic device 10 is merely illustrative of an exemplary embodiment incorporating an integration of different I/O functions as described in further detail below.

The electronic device 10 includes a housing 16 that defines the structural exterior surfaces of the electronic device 10. The housing 16 has an outer surface 18 configured to be held by the operator during use of the electronic device 10. The outer surface 18 defines an outer boundary having a top side 20, a bottom side 22 opposite the top side 20, and opposite lateral sides 24, 26. The housing 16 also includes or defines a front side 28 and a back side 30. One or more components of the user interface 12 are disposed along the front side 28 of the housing 16. The housing 16 may have a two-piece construction. In this exemplary embodiment, the housing 16 includes an upper shell 32 and a lower shell 34 that are coupled to one another. The upper shell 32 may be configured as a frame that surrounds and supports one or more I/O components. The lower shell 32 may be configured as a casing to cover the internal components of the device 10. In other examples, the housing 16 may include any number of components configured to act as a frame or a casing, and may be configured using other types of housing structures.

A number of symbols or indicia 36, 38 may be printed or otherwise provided on the outer surface 18 of the housing 16 to facilitate user interaction with these components of the user interface 12. In this way, the symbols or indicia 36, 38 mark the proximate location of corresponding user interface elements 14b of the user interface 12. In this example, the indicia 36, 38 are provided on one of the lateral sides 24 in an area in which one or more of the user interface elements 14 are located. Other indicia may be provided on other portions of the outer surface 18. In this case, the indicia 36 represent volume controls for the electronic device 10. For example, two dots are provided, with the first dot representing a volume up button and the second dot representing a volume down button. The indication 38 represents a slider or scroll button. For example, the symbol 38 may include a double-sided arrow indicating that the operator may slide a finger along the outer surface 18 in the vicinity of the arrow. Further details regarding the user interface elements 14b are provided below, but, as a general matter, each element 14b may be implemented via one or more touch sensing components disposed within the housing 16 proximate to the indicia 36, 38.

The electronic device 10 includes a socket connector 40 disposed along the bottom side 22. The socket connector 40 includes a female interface 42 configured to receive a corresponding male connector (not shown). In the illustrated embodiment, the socket connector 40 is represented by a micro-USB connector. The socket connector 40 may be used for connection to a power, data, or audio input. The female interface 42 is accessible through the bottom side 22. The socket connector 40 may be provided in other locations along the outer surface 18 of the housing 16. For example, a headphone jack may be provided in a location along the outer surface 18 for receiving a headphone plug. Other types of mating connectors and components may be incorporated in the electronic device 10 in alternative embodiments.

One or more components of the user interface 12 are coupled to, and disposed along, the front side 28 of the housing 16. In this example, the user interface 12 includes a touch-sensitive display 50. In some examples, the touch-sensitive display 50, in turn, includes a touch-sensitive cover 52, in which case the touch cover 52 may be separate from, and overlaid over, the display 50. For example, the display 50 may be mounted in an internal location relative to the front side 28 of the housing 16. The touch cover 52 may then overlay the display 50 and, in some cases, the front side 28 of the housing 16. The touch cover 52 may be transparent to allow the display 50 to be visible through the touch cover 52. The touch cover 52 may be made of one or more of a variety of different glass or plastic materials. In other examples, the touch-sensitive display 50 does not include a cover, but instead includes a glass block or other layer with one or more transducers, conductive elements, or other components (not shown) under or along one or more edges thereof. The touch-sensitive display 50 is not limited to any one particular type of touch sensing mechanism and may include acoustic, resistive, capacitive or other touch-sensitive components.

The touch-sensitive display 50 (with or without the touch cover 52) generally provides a touchscreen configured to sense a touch event by the operator. As such, the touch-sensitive display 50 constitutes one of the user interface elements 14a. Optionally, substantially the entire area (areas 54 and 56) of the touch-sensitive display 50 may be touched by the operator to control the functionality of the electronic device 10. Alternatively, the touch-sensitive display 50 may be segmented into one or more user input area(s) 54 and one or more display area(s) 56. Each user input area 54 corresponds with an area of the touch-sensitive display 50 that may be touched by the operator to control the electronic device 10. Each display area 56, in contrast, corresponds with a portion of the touch-sensitive display 50 that still displays data to the operator but is not touch-sensitive. The relative sizes of the user input area 54 and the display area 56 may change depending on the mode of operation of the electronic device 10 and/or the functionality allowed by the electronic device 10.

Optionally, the user input area 54 and display area 56 may at least partially overlap such that different data may be displayed in the user input area 54, such as to indicate to the operator different touch areas within the user input area 54. For example, different icons may be displayed in the user input area 54 indicating the particular zone within the user input area 54 that the operator is required to touch to perform a certain operation. The operator may touch a particular location in the user input area 54 to control the functionality of the electronic device 10. The operator may slide his/her finger along the touch-sensitive display 50 in the user input area 54 to control the functionality of the electronic device 10. A variety of different types of touch events, gestures, and movements of the operator finger may control the functionality of the electronic device 10.

In an exemplary embodiment, the user input area 54 and the display area 56 are bounded by a border 58 of the touch cover 52. Optionally, the border 58 may have a substantially uniform thickness around the perimeter of the touch cover 52. The border 58 covers a portion of the front side 28 of the housing 16 in this example. The border 58 may be transparent, or alternatively, may be translucent or opaque. The border 58 may be painted or coated. A separate component, such as a cover, may be coupled to the touch cover 52 to define the border 58.

FIG. 7 is an exploded, side view of the electronic device 10. The upper shell 32 includes a base 60 and a rim 62 extending from the base 60. The rim 62 defines sidewalls of the housing 16. The upper shell 32 has a component cavity 64 bounded by the base 60 and the rim 62. Similarly, the lower shell 34 includes a base 66 and a rim 68 extending from the base 66. The rim 68 defines sidewalls of the lower shell 34. The lower shell 34 has a component cavity 70 bounded by the base 66 and the rim 68. The base 60 defines the front side 28 of the housing 16. The base 66 defines the back side 30 of the housing 16. The rims 62, 68 engage one another when the housing 16 is assembled such that rims 62, 68 define the top side 20, the bottom side 22, and the lateral sides 24 and 26 (each shown in FIG. 6). When the upper and lower shells 32, 34 are coupled together, the component cavities 64, 70 are open to one another and define a larger component cavity of the housing 16. The rims 62, 68 engage one another to define sidewalls of the housing 16.

The upper and lower shells 32, 34 are shown separated from one another in FIG. 7. The component cavities 64, 70 receive electronic components of the electronic device 10 therein. For example, the component cavities 64, 70 receive the user interface elements 14a, 14b, 14c and the socket connector 40. The component cavities 64, 70 may also receive a battery pack 72, such as in the component cavity 70 of the lower shell 34. The electronic device 10 includes a circuit board 74 that is received in the component cavity 64 of the upper shell 32 and/or the component cavity 70 of the lower shell 34. The electronic device 10 may include more than one circuit board 74 in alternative embodiments. The display 50 of the user interface 12 is also configured to be received in the component cavity 64 of the upper shell 32. Other types of electronic components may be received in the component cavities 64, 70 in alternative embodiments depending on the particular application.

The user interface elements 14a, 14b, 14c are configured to be mounted or connected to the housing 16, including the user interface element 14a defined by the touch-sensitive display 50 (or touch cover 52). In some cases, the user interface elements 14a, 14b, 14c are structurally and operatively connected to the housing 16. To that end, one or more of the user interface elements 14a, 14b, 14c may be electrically coupled to a portion of the housing 16. To that end, the housing 16 may include a plurality of frame connectors 76 that act as respective interfaces between the user interface elements 14a, 14b, 14c and the circuit board 74. The frame connectors 76 are configured to make electrical contact with the circuit board 74 when the electronic device 10 is assembled. In an exemplary embodiment, the frame connectors 76 make an electrical connection with the circuit board 74 at several interfaces for ease of assembly of the electronic device 10. In an exemplary embodiment, the frame connectors 76 are electrically connected to the circuit board 74 without the use of solder or another type of permanent connection. As such, assembly of the electronic device 10 can be accomplished by simply loading the circuit board 74 into the component cavities 64, 70 of the upper shell 32 and/or the lower shell 34 such that the circuit board 74 engages the frame connectors 76. When the upper and lower shells 32, 34 are coupled together, such as by using fasteners or latches, an electrical connection is made between the frame connectors 76 and the circuit board 74. There is no additional soldering step required to electrically connect the frame connectors 76 to the circuit board 74. Additionally, an inexpensive connection may be made between the frame connectors 76 and the circuit board 74, such as by using spring contacts 78 between the circuit board 74 and the frame connectors 76. No additional connectors, such as plug and receptacle connectors, are required between the circuit board 74 and the frame connectors 76.

A variety of other connections and connection interfaces may be used to support electrical communication between the user interface elements 14a, 14b, 14c and the circuit board 74. Practice of the subject matter disclosed herein is not limited to the above-described frame connectors 76.

When assembled, the display 50 is electrically coupled to the circuit board 74. Control signals to control the data displayed by the display 50 are transmitted from the circuit board 74 to the display 50. The user interface element 14a is, in turn, configured to capture information regarding a user interaction with the display 50, such as a touch, gesture, or other handling event. A touch controller (described below) then processes the indication or signal to generate an indication or signal representation of that event. In an exemplary embodiment, the circuit board 74 includes a connector 80 and the display 50 includes a complementary connector 82 configured to be engaged by the connector 80. Any type of connector and complementary connector 80, 82 may be used. For example, the connector 80 and complementary connector 82 may constitute plug and receptacle type connectors. Alternatively, the connector 80 and complementary connector 82 may be card edge connectors, mezzanine connectors, spring beams and pads, pin and socket type connectors, and the like.

In this example, the touch cover 52 constitutes one of the user interface elements 14a. For example, as noted above, the touch cover 52 is configured to be touched by the operator to control the functionality of the electronic device 10. The touch cover 52 includes one or more tactile sensors 90 along an inner surface 92 of the touch cover 52. The touch cover 52 also includes an outer surface 94 opposite the inner surface 92 that is configured to be touched by the operator. When the touch cover 52 is coupled to the housing 16, the tactile sensors 90 are electrically connected to corresponding frame connectors 76a of the housing 16.

In the illustrated embodiment, the housing 16 includes frame connectors 76a provided on the outer surface 18 of the base 60 of the housing 16. For example, the frame connectors 76a are provided on the front side 28 of the housing 16. In an exemplary embodiment, the frame connectors 76a constitute conductive traces provided on the housing 16. Optionally, the conductive traces may be embedded in the body of the housing 16 defining the base 60. The frame connectors 76a include a first interface 96 and a second interface 98. The tactile sensors 90 of the touch cover 52 include one or more terminals 100 that are configured to engage the first interface 96. The circuit board 74, in turn, engages the second interface 98. In an exemplary embodiment, one or more of the spring contacts 78a are provided between the circuit board 74 and the second interface 98 of the frame connector 76a. The spring contacts 78a define a separable interface between the circuit board 74 and the second interface 98. The housing 16 and corresponding frame connector 76a define an interconnect between the touch cover 52 and the circuit board 74. In an exemplary embodiment, the touch cover 52 is electrically and mechanically coupled to the housing 16 by the interface between the tactile sensors 90 and the first interface 96. Optionally, a conductive epoxy may be used between the tactile sensors 90 and the first interface 96.

In an exemplary embodiment, the tactile sensors 90 are configured to sense a touch event by the operator. Optionally, the tactile sensors 90 may constitute piezoelectric sensors, which may be referred to hereinafter as piezoelectric sensors 90. The piezoelectric sensors 90 are configured to sense a touch event by the operator using a piezoelectric effect. For example, the piezoelectric sensors 90 may generate an electric potential and/or electric signal in response to applied mechanical stress on the touch cover 52. The mechanical stress may be transferred across the interface between the piezoelectric sensors 90 and the inner surface 92. As such, ultrasonic, sonic (e.g., audio frequency range), or subsonic energy from the touch cover 52 is transferred to the piezoelectric sensors 90 in the form of pressure that is sensed at the piezoelectric sensor 90. The energy generates an electric potential that is transmitted by the terminals 100 to the frame connector 76a, and the frame connector 76a to the circuit board 74. Having the piezoelectric sensors 90 and the touch cover 52 rigidly held to the housing 16 maintains the transfer of energy across the interface between the piezoelectric sensors 90 and the frame connector 76a. Using a conductive epoxy therebetween also maintains the transfer of electric potential across the interface. As such, an accurate reading of the touch event may be communicated to the circuit board 74 to adjust the display 50.

Other types of tactile sensors 90 may be used in alternative embodiments in addition to, or other than, piezoelectric sensors. For example, capacitive sensors, resistive sensors, magnetic sensors, optical sensors, mechanical sensors and the like may be used to sense touch events by the operator on the touch cover 52. Optionally, the tactile sensor 90 may include a selective conductive coating to capacitively sense touch events. The tactile sensor 90 may be embedded in the touch cover 52. Both a piezoelectric sensor and another type of sensor, such as a capacitive sensor, may be jointly electrically connected to the circuit board via the housing 16, and signals from both may be jointly used to determine a response and/or to adjust the display 50.

In an exemplary embodiment, at least one user interface element 14b is provided in the upper shell 32 and at least one user interface element 14c is provided in the lower shell 34. Each user interface element 14b may be coupled to, or mounted on, the rim 62 and/or the base 60. Each user interface element 14b may include one or more terminal(s) 110 coupled to a corresponding frame connector 76b. The frame connector 76b is a conductive trace routed along the rim 62 and/or the base 60. In some cases, the user interface elements 14b, 14c may also include conductive traces routed along the rim 62, the base 60, and/or other component of the housing 16, as described further below. The frame connector 76b includes a first interface 112 and a second interface 114, which may be at generally opposite ends of the conductive trace. The terminals 110 of the user interface element 14b are coupled to the first interface 112. The circuit board 74 is coupled to the second interface 114. The housing 16 and corresponding frame connector 76b define an interconnect between the user interface element 14b and the circuit board 74. In an exemplary embodiment, the user interface element 14b is electrically and mechanically coupled to the housing 16 by the interface between the terminals 110 and the first interface 112. Optionally, a conductive epoxy may be used between the terminals 110 and the first interface 112.

In an exemplary embodiment, one or more of the spring contacts 78b are provided between the circuit board 74 and the second interface 114 of the frame connector 76b. The spring contacts 78b define a separable interface between the circuit board 74 and the second interface 114. Other types of connections may be made in alternative embodiments between the frame connector 76b of the housing 16 and the circuit board 74. Optionally, the spring contact 78b may be mounted on the circuit board 74 and coupled to the frame connector 76b during assembly of the circuit board 74 into the upper shell 32. Alternatively, the spring contacts 78b may be mounted on the frame connector 76b and engaged with the circuit board 74 during assembly of the circuit board 74 into the upper shell 32.

The user interface element 14c is coupled to the rim 68 and/or the base 66 and the user interface element 14c includes one or more terminal(s) 120 coupled to a corresponding frame connector 76c. The frame connector 76c is a conductive trace routed along the base 66 and/or the rim 68. The frame connector 76c includes a first interface 122 and a second interface 124, which may be at generally opposite ends of the conductive trace. The terminals 120 of the user interface element 14c are coupled to the first interface 122. The circuit board 74 is coupled to the second interface 124. The housing 16 and corresponding frame connector 76c define an interconnect between the user interface element 14c and the circuit board 74. In an exemplary embodiment, the user interface element 14c is electrically and mechanically coupled to the housing 16 by the interface between the terminals 120 and the first interface 122. Optionally, a conductive epoxy may be used between the terminals 120 and the first interface 122.

In an exemplary embodiment, one or more of the spring contacts 78c are provided between the circuit board 74 and the second interface 124 of the frame connector 76c. The spring contacts 78c define a separable interface between the circuit board 74 and the second interface 124. Other types of connections may be made in alternative embodiments between the frame connector 76c of the housing 16 and the circuit board 74. Optionally, the spring contact 78c may be mounted on the circuit board 74 and coupled to the frame connector 76c during assembly of the lower shell 34 onto the upper shell 32 or assembly of the circuit board 74 into the lower shell 34, depending on the assembly process. Alternatively, the spring contacts 78c may be mounted on the frame connector 76c and engaged with the circuit board 74 during assembly of the circuit board 74 and/or the lower shell 34.

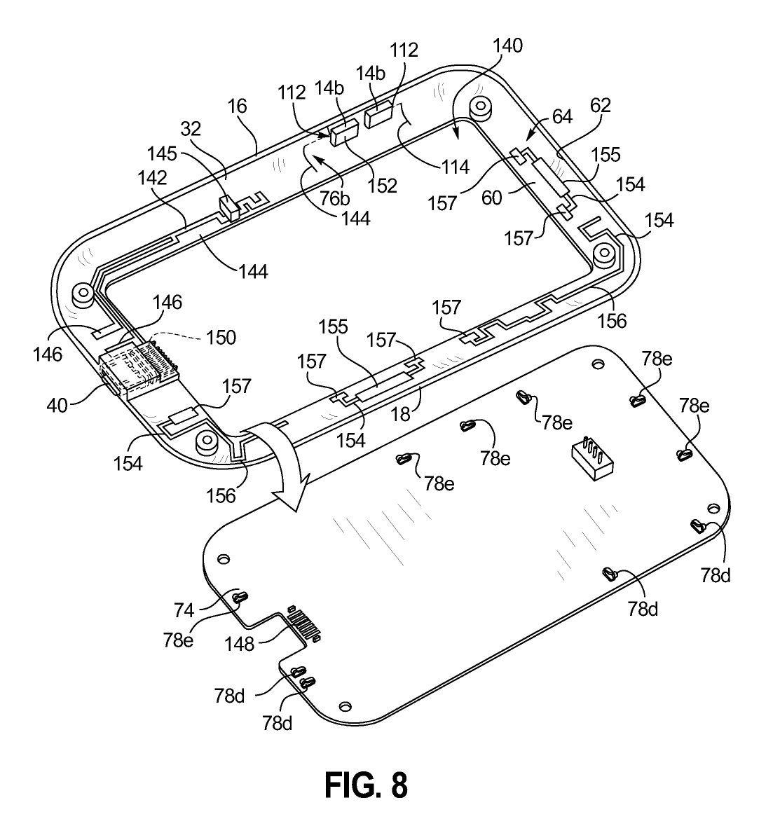

FIG. 8 is a bottom perspective view of the upper shell 32. The upper shell 32 includes the base 60 and the rim 62. The upper shell 32 further includes the component cavity 64. In an exemplary embodiment, an opening 140 is provided in the base 66. The opening 140 is configured to receive the display 50. The opening 140 provides access to the display 50 such that the display 50 may be visible external of the upper shell 32 to display data to the operator. Optionally, the opening 140 may be sized substantially similar to the display 50. The display 50 may substantially fill the opening 140. Optionally, the display may be coupled to the opening 140 to hold the display 50 in position with respect to the base 60. For example, the display 50 may be snap fit into the opening 140. Alternatively, the upper shell 32 may include securing features for securing the display 50 with respect to the opening 140 to hold the display 50 in place.

In an exemplary embodiment, the electronic device 10 includes an antenna 142 provided on an inner surface 144 of the upper shell 32. Optionally, the antenna 142 may be provided on the inner surface 144 of the base 60. The antenna 142 may be provided on the inner surface 144 of the rim 62 in addition to, or alternative to, the base 60. The antenna 142 may be a printed circuit on the inner surface 144 having a predetermined layout and configuration. Alternatively, the antenna 142 may be embedded in the body of the upper shell 32. Optionally, the antenna 142 may include a tuning device 145 (as seen in FIGS. 1 and 8) electrically coupled to the antenna 142. The tuning device 145 allows the antenna to be tuned to multiple frequency bands, such as by application of a DC voltage to the antenna 142. Optionally, the DC voltage may be applied to antenna input pads (not shown). The tuning device 145 may include discrete elements or parts directly mounted on the upper shell 32. Alternatively, the tuning device 145 may have parts or elements mounted on a circuit board mounted on, or coupled to, the upper shell 32. The circuit board may be the circuit board 74. The tuning device 145 may include a tunable capacitive element, such as a barium-strontium-titanate (BST) capacitor, a blocking capacitor, MEMS switched or other MEMS capacitor, a FET switched capacitor, a varactor diode (e.g., in receiving applications), and/or an ESD protection device. The capacitive element of the tuning device 145 may be separate and discrete from the capacitive filter 222 shown in FIG. 1. The tuning device 145 is schematically shown in FIG. 1 as part of the antenna 202, but may be coupled to the antenna 202 in a variety of ways, including, for instance, along the path between the wireless circuitry 204 and the antenna 202. A tuning voltage (e.g., 0 to 20 Volts DC) may be applied to the BST or other capacitor through the antenna input through a bias tee.

The antenna 142 includes mounting pads 146 that are configured to be electrically connected to the circuit board 74. In an exemplary embodiment, one or more spring contact(s) 78d are disposed on the circuit board 74 and are configured to engage the mounting pads 146 when the circuit board 74 is loaded into the component cavity 64 of the upper shell 32. Alternatively, the spring contacts 78d may be disposed on the mounting pads 146 and configured to engage corresponding pads on the circuit board 74 when the circuit board 74 is loaded into the component cavity 64 of the upper shell 32. Other types of interconnects are possible between the mounting pads 146 of the antenna 142 and the circuit board 74.

As described further below, the conductive structure presented by the antenna 142 may also be coupled via the spring contacts 78d to a capacitive touch controller (see, e.g., FIG. 1) to act as a capacitive touch interface. That is, the conductive traces of the antenna 142 may be used for both radio frequency (RF) communications and for capturing user touch events, gestures, and other interaction with the housing 16 in the vicinity of the antenna 142.

The socket connector 40 is mounted to the upper shell 32 and is configured for electrical connection to mounting pads 148 on the circuit board 74. The socket connector 40 includes spring contacts 150 that engage the mounting pads 148 when the circuit board 74 is loaded into the component cavity 64 of the upper shell 32. The spring contacts 150 are biased against the mounting pads 148 to ensure electrical contact therebetween. As such, the socket connector 40 is configured to be electrically connected to the circuit board 74 at a separable interface. The socket connector 40 is mechanically secured within the upper shell 32 prior to assembly of the circuit board 74 into the upper shell 32. As such, the socket connector 40 may be securely held within the upper shell 32 and may be sealed to the upper shell 32 in a cost effective and reliable manner. For example, the socket connector 40 may be provided with electro-static discharge (ESD) protection, electro-magnetic interference (EMI) shielding and/or waterproofing. Because the socket connector 40 is integrated into the upper shell 32, as opposed to being mounted on the circuit board 74, the ESD protection, EMI shielding and/or waterproofing may be made in a reliable manner. Additionally, the ESD protection, EMI shielding and/or waterproofing may be made prior to the circuit board 74 being assembled into the upper shell 32, which may allow more room for assembly, which, in turn, may make assembly easier.

The user interface elements 14b are coupled to the rim 62 and/or the base 60 independent of the circuit board 74. The user interface elements 14b are coupled to the upper shell 32 in an assembly step separate from the circuit board 74 being coupled to the upper shell 32. In some cases, one or more of the user interface elements 14b may be rigidly held to the rim 62 and/or base 60 using a conductive epoxy such that the user interface elements 14b are rigidly held against the inner surface 144 of the upper shell 32. Alternatively or additionally, one or more of the user interface elements 14b may be deposited on the upper shell 14b using a printing, plating, or other deposition process, which may also be used for the antenna 142. As described herein, a variety of different types of user interface elements 14 may additionally, or alternatively, be integrated into the upper shell 32. In an exemplary embodiment, the user interface elements 14b are piezoelectric sensors, and may be referred to hereinafter as piezoelectric sensors 14b. The piezoelectric sensors 14b generate an electric field or electric potential in response to applied mechanical stress on the upper shell 32. For example, pressure, such as ultrasonic, sonic (e.g., audio range), or subsonic energy, imparted onto the upper shell 32, such as on the rim 62 proximate to the piezoelectric sensors 14b, is transferred through the body of the upper shell 32 directly to the piezoelectric sensors 14b. Having the piezoelectric sensors 14b mechanically secured to the inner surface 144 of the upper shell 32 maintains the interface therebetween. Tight coupling of the piezoelectric sensors 14b to the upper shell 32 maintains energy transfer across the interface. For example, epoxy or a conductive epoxy may be used to secure the piezoelectric sensors 14b to the inner surface 144. Other types of user interface elements 14b may be provided in alternative embodiments, rather than or in addition to, piezoelectric sensors, to define tactile sensors. For example, the user interface elements 14b may be capacitive sensors, resistive sensors, magnetic sensors, optical sensors, mechanical sensors and the like in alternative embodiments. Both a piezoelectric sensor and another type of sensor, such as a capacitive sensor, may be jointly electrically connected to the circuit board via the housing 16, and signals from both may be jointly used to determine a response and/or to adjust the display 50.

The user interface elements 14b may be provided anywhere along the inner surface 144, such as in locations designated for a particular functionality. For example, volume control scrolling, navigation or movement, activation or deactivation, or other functionality may be provided by the particular user interface elements 14b. Indicia, such as the indicia 36, 38 (FIG. 6) may be provided on the outer surface 18 of the upper shell 32 opposite of the user interface elements 14b. The indicia 36, 38 may indicate to the operator the function provided by the user interface elements 14b. The user interface elements 14b thus operate as virtual buttons or controllers for the electronic device 10. For example, the user interface elements 14b are not physically touched by the operator, but rather the user interface elements 14b sense when the operator touches a particular area of the upper shell 32 to control the functionality of the electronic device 10.

In an exemplary embodiment, the user interface elements 14b include a transducer 152 and the terminals 110 (FIG. 7). The terminals 110 are coupled to the corresponding frame connector 76b. The frame connector 76b is routed along the inner surface 144 of the upper shell 32 to an appropriate location for engagement with the circuit board 74. For example, the frame connector 76b may constitute a conductive trace routed on the inner surface 144 to a location on the base 60 designated for connection to the circuit board 74.

The frame connector 76b includes the first interface 112 and the second interface 114. The terminals 110 of the user interface element 14b are coupled to the first interface 112. The circuit board 74 is coupled to the second interface 114. For example, the spring contacts 78b may be provided between the circuit board 74 and the second interface 114 to couple the circuit board 74 to the second interface 114. The spring contacts 78b define a separable interface between the circuit board 74 and the second interface 114. Other types of connections may be made in alternative embodiments between the frame connector 76b of the housing 16 and the circuit board 74. Optionally, the spring contact 78b may be mounted on the circuit board 74 and coupled to the frame connector 76b during assembly of the circuit board 74 into the upper shell 32. Alternatively, the spring contacts 78b may be mounted on the frame connector 76b and engaged with the circuit board 74 during assembly of the circuit board 74 into the upper shell 32.

The housing 16 and corresponding frame connector 76b define an interconnect between the user interface element 14b and the circuit board 74. In an exemplary embodiment, the user interface element 14b is electrically and mechanically coupled to the housing 16 by the interface between the terminals 110 and the first interface 112. Optionally, a conductive epoxy may be used between the terminals 110 and the first interface 112.

With continued reference to the example of FIG. 8, the upper shell 32 has a number of additional conductive structures 154 printed, plated, or otherwise deposited on the upper shell 32 to support additional I/O functions. Some of the conductive structures 154 may support a single I/O function (e.g., RF communications for one or more communication bands or protocols), while other conductive structures 154 may support more than one I/O function (e.g., both RF communications and touch-sensitive user interfaces), as described herein. Regardless of the I/O function(s) involved, each conductive structure 154 may include conductive traces deposited on the upper shell 32 using a common process (e.g., electroplating, injection molding, etc.) and, thus, be formed with the same material(s). In this example, the conductive structures include a pair of capacitive touch electrodes 155 and a pair of antenna elements 156. The capacitive touch electrodes 155 are coupled to touch control circuitry (see, e.g., FIG. 1) to generate an indication of operator interaction with the portion of the housing 16 in the vicinity thereof. The antenna elements 156 may be coupled to corresponding wireless circuitry to support one or more RF communication bands (e.g., Bluetooth, Wi-Fi, GPS, mobile telephone, etc.). The antenna elements 156 may provide redundancy for a particular band as described above to allow the wireless electronics to select an antenna given the position of an operator's hand. To these ends, each conductive structure 154 may include one or more contact pads or other terminals 157 for engagement with corresponding spring contacts 78e on the circuit board. As described herein, one or both of the antenna elements 156 may also be coupled to the touch control circuitry to act as capacitive touch electrodes as well. In this way, the touch control circuitry can provide an indication of whether the operator's hand is touching or otherwise covering a portion of the antenna element 156. In some cases, the indication may also be representative of the location on the antenna element 156 being touched or covered. Alternatively or additionally, the capacitive touch electrodes 155 are disposed alongside or adjacent to the antenna elements 156 to provide the indication regarding the location of the operator's hand.

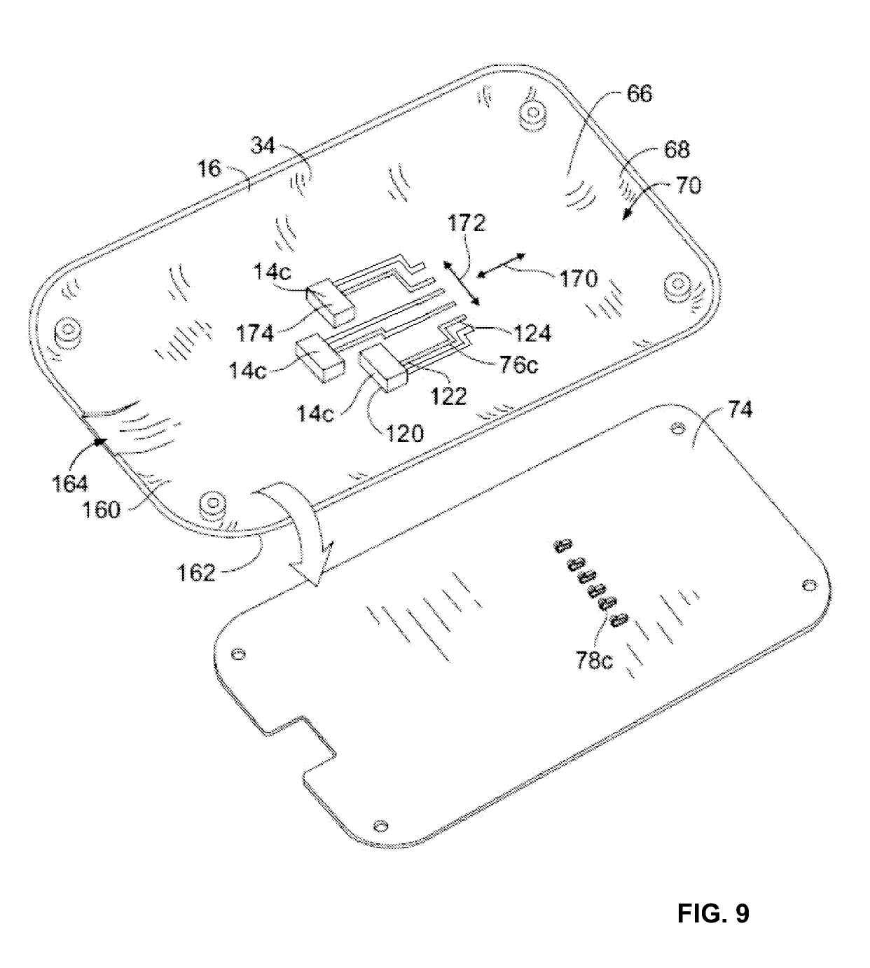

FIG. 9 is a top perspective view of the lower shell 34. The lower shell 34 includes the base 66 and the rim 68. The lower shell 34 includes the component cavity 70. The lower shell 34 includes an inner surface 160 and an outer surface 162. The outer surface 162 defines the outer surface of the housing 16 and is configured to be held and touched by the operator. The lower shell 34 includes an opening 164 through the rim 68 that accommodates the socket connector 40 (FIGS. 6-8) when the lower shell 34 is coupled to the upper shell 32.

The user interface elements 14c are coupled to the base 66 independent of the circuit board 74. Optionally, the user interface elements 14c may be coupled to the rim 68 in addition to, or in the alternative to, the base 66. The user interface elements 14c are coupled to the lower shell 34 independent of the circuit board 74. The user interface elements 14c may be rigidly held to the base 60 using a conductive epoxy such that the user interface elements 14c are rigidly held against the inner surface 160 of the lower shell 34. Alternatively, each user interface element 14c may be printed, plated, or otherwise deposited on the lower shell 34 using any desired manufacturing process, including those used for depositing the antenna elements on one or more components of the housing 16. Other types of user interface elements 14 may additionally, or alternatively, be integrated into the lower shell 34. In an exemplary embodiment, the user interface elements 14c include piezoelectric sensors, and may be referred to hereinafter as piezoelectric sensors 14c. The piezoelectric sensors 14c generate an electric field or electric potential in response to applied mechanical stress on the lower shell 34. For example, pressure, such as ultrasonic or subsonic energy, imparted onto the lower shell 34, such as on the base 66 proximate to the piezoelectric sensors 14c, is transferred through the body of the lower shell 34 directly to the piezoelectric sensors 14c. Having the piezoelectric sensors 14c mechanically secured to the inner surface 160 of the lower shell 34 maintains the energy the interface therebetween. Tight coupling of the piezoelectric sensors 14c to the lower shell 34 maintains energy transfer across the interface. For example, epoxy or a conductive epoxy may be used to secure the piezoelectric sensors 14c to the inner surface 160. Other types of user interface elements 14c may be provided in alternative embodiments, rather than, or in addition to, piezoelectric sensors, to define tactile sensors. For example, the user interface elements 14c may be capacitive sensors (such as the capacitive touch interfaces described above in connection with the other embodiments of the disclosed devices), resistive sensors, magnetic sensors, optical sensors, mechanical sensors and the like in alternative embodiments. Both a piezoelectric sensor and another type of sensor, such as a capacitive sensor, may be jointly electrically connected to the circuit board via the housing 16, and signals from both may be jointly used to determine a response and/or to adjust the display 50.

The user interface elements 14c may be provided anywhere along the inner surface 160, such as in locations designated for a particular functionality. For example, in the illustrated embodiment, the user interface elements 14c are substantially centrally positioned on the base 66 in an array to sense movement of the operator's finger along the outer surface 162 of the base 66. As such, the user interface elements 14c cooperate to define a navigation or movement sensor similar to a mouse or scroll device. The user interface elements 14c sense movement of the user's finger in one or more directions, such as in a longitudinal direction 170 and a lateral direction 172. Such movement may translate into movement of a cursor on the display 50 (FIG. 6), movement of icons within the display 50, or other types of movements or functions. Indicia may be provided on the outer surface 162 of the lower shell 34 opposite of the user interface elements 14c. The indicia may indicate to the operator the function provided by the user interface elements 14c. The user interface elements 14c thus operate as virtual buttons or controllers for the electronic device 10. For example, the user interface elements 14c are not physically touched by the operator, but rather the user interface elements 14c sense when the operator touches a particular area of the lower shell 34 to control the functionality of the electronic device 10.

In an exemplary embodiment, the user interface elements 14c include a transducer 174 and the terminals 120. The terminals 120 are terminated to the corresponding frame connectors 76c. The frame connectors 76c are routed along the inner surface 160 of the lower shell 34 to an appropriate location for mating connection with the circuit board 74. For example, the frame connector 76c may constitute a conductive trace routed on the inner surface 160 to a location on the base 66 designated for connection to the circuit board 74. Optionally, each of the frame connectors 76c may be routed to the same general area for connection to the circuit board 74. The conductive trace of each frame connector 76c may be deposited using the same manufacturing process steps used to deposit antenna electrodes and other conductive structures on the housing 16. In other embodiments, the user interface elements 14c may include additional conductive traces instead of the transducers 174 in order to form a capacitive touch interface.

The housing 16 and corresponding frame connectors 76c define an interconnect between the user interface element 14c and the circuit board 74. In an exemplary embodiment, the user interface element 14c is electrically and mechanically coupled to the housing 16 by the interface between the terminals 120 and the first interface 112. Optionally, a conductive epoxy may be used between the terminals 120 and the first interface 122.

Further details regarding the structure, assembly, and construction of the electronic device 10 are set forth in co-pending and commonly assigned U.S. application Ser. No. 12/775,977 (“Integrated Connection System for an Electronic Device”), the entire disclosure of which is hereby incorporated by reference.

Various embodiments described herein can be used alone or in combination with one another. The foregoing detailed description has described only a few of the many possible implementations of the present invention. For this reason, this detailed description is intended by way of illustration, and not by way of limitation.

The above description is intended to be illustrative, and not restrictive. The above-described embodiments (and/or aspects thereof) may be used in combination with one another. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

1. An electronic device comprising:
a housing defining first and second user interface areas;
a touch-sensitive display disposed in the first user interface area;
a conductive structure disposed along the housing in the second user interface area;
a capacitive touch controller disposed within the housing and coupled to the conductive structure, the capacitive touch controller being configured to capture user interaction with the conductive structure; and
a transceiver disposed within the housing and coupled to the conductive structure, the transceiver being configured for radio frequency (RF) communications;
wherein the conductive structure is configured for operation as an antenna to support the RF communications.

2. The electronic device of claim 1, further comprising a processor connected with the transceiver and the capacitive touch controller, the processor being configured to adjust a configuration of the transceiver based on an indication of the user interaction generated by the capacitive touch controller.

3. The electronic device of claim 2, wherein the indication is representative of an operator's hand covering the antenna, and wherein the processor is configured to retune the transceiver and/or the antenna based on the indication.

4. The electronic device of claim 3, wherein the indication is further representative of a location on the antenna covered by the operator's hand.

5. The electronic device of claim 1, wherein the conductive structure includes a conductive trace disposed on the housing.

6. The electronic device of claim 1, wherein the conductive structure includes a plurality of conductive traces disposed along the housing.

7. The electronic device of claim 6, wherein the plurality of conductive traces are disposed in a single-layer arrangement.

8. The electronic device of claim 1, further comprising a further conductive structure disposed along the housing in the second user interface area, the further conductive structure being coupled to the capacitive touch controller and not the transceiver.

9. The electronic device of claim 1, wherein the conductive structure is coupled to the capacitive touch controller via a low bandpass filter configured to block signal frequencies of the RF communications, and wherein the conductive structure is coupled to the transceiver via a high bandpass filter configured to block signal frequencies of the capacitive touch controller.

10. An electronic device comprising:
a housing;
an antenna disposed along the housing, said antenna comprising a conductive trace;
a transceiver providing radio frequency (RF) communications, the transceiver being coupled to the antenna;
a capacitive touch controller coupled to the antenna, the capacitive touch controller being configured to generate an indication of a conduction environment for the antenna based on capacitive sensing using the conductive trace; and
a processor coupled to the transceiver and the capacitive touch controller, the processor being configured to adjust the configuration of the transceiver based on the indication generated by the capacitive touch controller.

11. The electronic device of claim 10, wherein the antenna is disposed in a user interface area along the housing, and wherein the electronic device further comprises a touch-sensitive display supported by the housing in an area other than the user interface area of the antenna.

12. The electronic device of claim 10, wherein the indication is representative of a user interaction with the housing that changes the conduction environment for the antenna.

13. The electronic device of claim 10, wherein the indication is representative of an operator's hand covering the antenna, and wherein the processor is configured to retune the transceiver and/or the antenna based on the indication.

14. The electronic device of claim 13, wherein the indication is further representative of a location on the antenna covered by the operator's hand.

15. The electronic device of claim 10, wherein the conductive trace is disposed on the housing.

16. The electronic device of claim 10, wherein the conductive trace of the antenna is one of a plurality of conductive traces disposed along the housing.

17. The electronic device of claim 16, wherein the plurality of conductive traces are disposed in a single-layer arrangement.

18. A method for input/output operation of an electronic device, the method comprising:
sensing a capacitive interaction of a user on a conductive structure of the electronic device, said conductive structure also operating as an antenna element for the electronic device;
configuring a transceiver of the electronic device as a function of the capacitive interaction, the transceiver coupled to the antenna element; and
transmitting or receiving radio frequency (RF) communications via the transceiver as configured.

19. The method of claim 18, wherein transmitting or receiving RF communications includes transmitting or receiving RF communications via the conductive structure.

20. The method of claim 18, wherein configuring the transceiver includes retuning the transceiver and/or antenna(s) based on the capacitive interaction.
